(19) United States
(12) Patent Application Publication
(10) Pub. No.: US 2010/0103849 A1
(43) Pub. Date: Apr. 29, 2010

(54) POWER-SAVING CONTROL METHOD FOR WIRELESS LAN

(76) Inventors: Hsien-Kang Wang, Taipei (TW); Chih-Yi Chen, Taipei (TW); Sheng-Feng Yang, Taipei (TW)

Correspondence Address: Dr. BANGER SHIA;Patent Office of Bang Shia, 102 Lindencrest Ct., Sugar Land, TX, 77479-5201, US

(21) Appl. No.: 12/581,134

(22) Filed: Oct. 17, 2009

(30) Foreign Application Priority Data
Oct. 23, 2008 (TW) 97140581

(51) Int. Cl. G08C 17/02

(52) U.S. Cl. 370/311

(57) ABSTRACT

A power-saving control method for wireless LAN is applied to a portable electronic device, such as laptop computer. When the portable electronic device is booted and drives the wireless LAN device, the scan function of the wireless LAN device is disabled. Therefore, automatically scanning the wireless access point is avoided to save power. Moreover, after the wireless LAN link is established by the user, the scan function of the wireless LAN device is also disabled. Thus, the periodical automatic scanning the wireless access point is avoided to save power.

### BACKGROUND OF THE INVENTION

1. Field of the Invention

The invention relates to a power-saving control method for wireless LAN, more particularly, to a power-saving control method for wireless LAN in a portable electronic device.

2. Description of the Related Art

Currently, various portable electronic devices support wireless network universally. Generally speaking, for convenience in use, when the portable electronic device is booted, the system automatically performs the wireless network function and scans all usable wireless access points in the current receiving range automatically. Thus, it is convenient for users to select a link to be established and increase the speed of establishing the link.

For a portable electronic device such as a notebook computer, the battery life is paid more attention. However, as far as the notebook computer is concerned, the improvement of the power consumption is near bottleneck. In terms of the whole operation of a computer system, the power consumption of the wireless network is about above 10 to 20 percent of the whole power consumption. The proportion may be higher for a notebook computer with a small size. The power consumption of the wireless network depends on the distance between the portable electronic device and the linked the Wireless access point and size of the transmission data. On the other hand, in the whole operation process, the power consumption in scanning the wireless access points is far higher than the power consumption after establishing the link. When scanning the access points, the wireless network device automatically scans with greatest power in its maximum receiving range. The power consumption even may reach up to above 30%.

To solve the above-mentioned problem, part of notebook computers are designed with hardware switches, and then a user can directly power off the wireless network hardware via the hardware switch of the wireless network. Thus, the problem of consuming vast power in automatically scanning the wireless access point as soon as the notebook computer is booted is solved. However, the hardware switch causes extra costs, and besides the cost of the switch itself. A case, a circuit board and a circuit have to be redesigned. Thus, in some conventional methods, hotkeys are considered to be used to replace the hardware switch, and then the costs can decrease slightly. However, to the operating custom of a user, he often forgets to switch off the network hardware switch when shutting down the system. Therefore, the system still starts the automatic scanning function of the wireless network in next booting, and the conventional method cannot actually save power.

The other shortcoming of the method of powering off the wireless network hardware is that when a user wants to use the wireless network, he has to re-drive the wireless network hardware before establishing a network link, which wastes time and is inconvenient. On the other hand, besides automatically scanning after booting, even though the link is established, the wireless network hardware still regularly scans the usable wireless access points within the receiving range automatically to allow the user to update and replace the linked wireless access point at any time conveniently. The method of powering off the hardware described above cannot avoid the vast power consumption resulting from the periodic automatic scanning

To solve the power consumption problem of the wireless network, the conventional method mainly aims at after the link is established, setting a sleep mode, engaging special transmission timing with the access point, designing the package or cumulating transmission to reduce the using time of the wireless network. However, as for the automatic scanning stage which consumes power greatly, no matter it is the automatic scanning after booting or periodic scanning after establishing the link, it cannot be excluded. Thus, only transmission which has lower power consumption may be improved.

### BRIEF SUMMARY OF THE INVENTION

The invention discloses a power-saving control method for wireless LAN. After a portable electronic device receives a booting signal to boot, a basic input/output system (BIOS) is loaded to the portable electronic device, and a control chipset and a memory are initialized. When the operating system is started, it loads the driver of the wireless network device and combines the disable signal with the driver. When the operating system loads the driver, the disable signal is automatically transmitted to the wireless network device. A scanning module of the wireless network device can be closed via the disabled signal. Thus, the automatic scan performed by the scanning module of the wireless network device after the portable electronic device is booted is avoided to save power.

On the other hand, after the portable electronic device receives the signal for establishing wireless network link, the user selects a wireless access point from the wireless access point list to link. After linking with the selected wireless access point, the portable electronic device sends a disabled signal to the wireless network device to close the scanning module of the wireless network device via the wireless network link establishing program combined with the disabled signal. The periodic automatic scanning during the link process of the wireless network device is avoided. Then power is saved.

These and other features, aspects, and advantages of the present invention will become better understood with regard to the following description, appended claims, and accompanying drawings.

### BRIEF DESCRIPTION OF THE DRAWINGS

FIG. 1 is a schematic diagram showing the portable electronic device for which the power-saving control method for wireless LAN according to an embodiment of the invention is adapted;

FIG. 2 is a flow chart of a power-saving control method for wireless LAN according to an embodiment of the invention;

FIG. 3 is a flow chart of a power-saving control method for wireless LAN according to another embodiment of the invention; and

FIG. 4 is a flow chart showing the steps of establishing a link in the embodiment illustrated in FIG. 2 of the power-saving control method for wireless LAN.

### DETAILED DESCRIPTION OF THE EMBODIMENTS

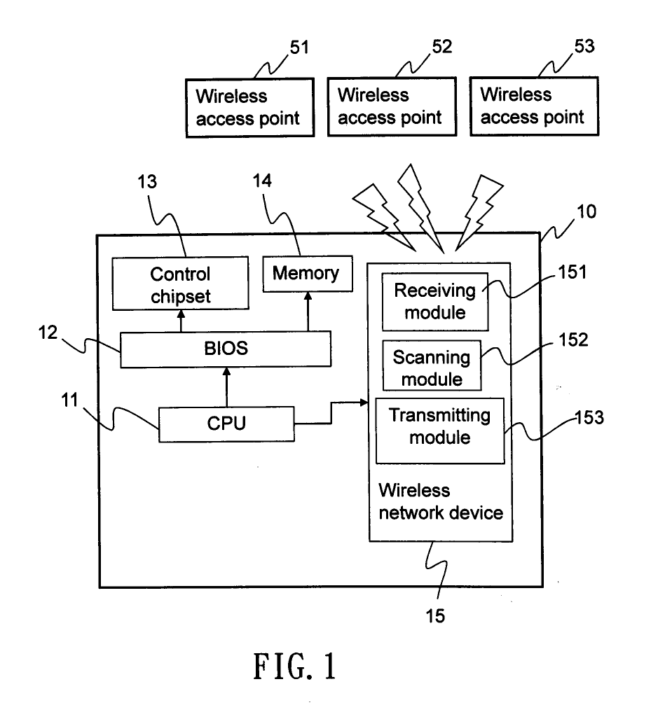

A power-saving control method for wireless LAN according to the invention is applied to a portable electronic device 10 such as a notebook computer. FIG. 1 is a schematic diagram showing the portable electronic device 10.

The portable electronic device 10 has a wireless network device 15 for transmitting data wirelessly. The wireless network device 15 may be a wireless network card, a wireless network chip and so on. The wireless network device 15 receives the data from the wireless access points 51, 52 and 53 via a receiving module 151, and it may transmit data to the wireless access points 51, 52 and 53 via the transmitting module 153.

After the conventional portable electronic device 10 is booted, the wireless network device 15 scans automatically via the scanning module 152 and searches all the wireless access points 51, 52 and 53 in the current transmission range to obtain a wireless access point list. Thus, the user is allowed to conveniently establish a link subsequently. Since all the wireless access points 51, 52 and 53 in the transmission range need to be scanned, the maximum power is used to make the scan. Therefore, the power consumption is the highest. At the same time, if the user does not establish the wireless network link after the computer is booted, the wireless network device 15 still regularly and automatically scans by the scanning module 152. Thus, when the user wants to establish the wireless network link, the scanning module 152 may have already scanned for more than ten times automatically. The cumulative consumed power reaches to a considerable total.

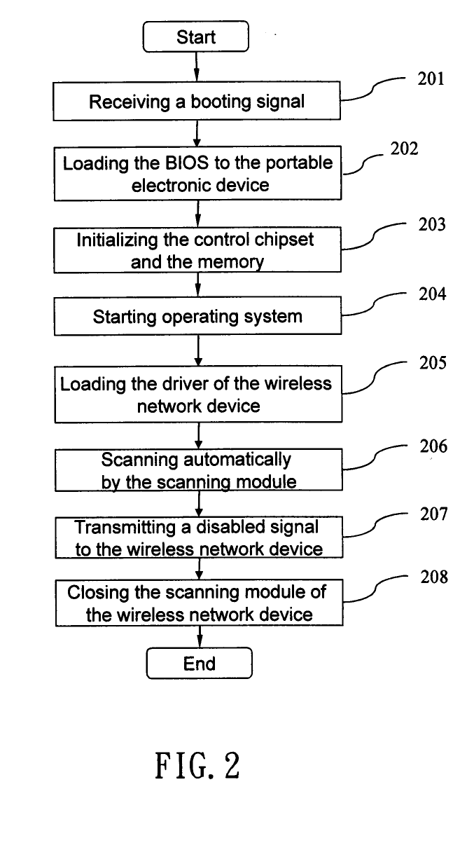

The power consumption problem resulting from automatically scanning after booting needs to be resolved. FIG. 2 is a flow chart of a power-saving control method for wireless LAN according to an embodiment of the invention.

The method is illustrated with the FIG. 1 and FIG. 2. First, a booting signal inputted by a user is received (step 201). Generally speaking, the user presses the power button (not shown) of the portable electronic device 10 to start the system. Then, a basic input/output system (BIOS) 12 is loaded to the portable electronic device 10 (step 202). The BIOS 12 can be regarded as a micro operating system used to communicate with hardware, and it is generally written in a combination language which aims at a compatible central processing unit (CPU) 11. Afterward, a control chipset 13, a memory 14 and periphery hardware devices and so on are initialized (step 203).

Then, the operating system (OS) (step 204) is started. At that moment, since the portable electronic device 10 has the wireless network device 15, the operating system (OS) loads the driver of the wireless network device 15 subsequently (step 205). Then, the system performs an automatic scan via the scanning module 152 of the wireless network device 15 and searches the wireless access points 51 to 53 in the transmission range to obtain a wireless access point list (step 206). If a user wants to establish a link, the list is a basis for selecting. However, this step is an optional step. If the user wants to save power completely, this step can be omitted.

At this time, a disabled signal is transmitted to the wireless network device 15 (step 207) to close the scanning module 152 of the wireless network device 15 (step 208). Thus, the disabled signal can be combined with the driver of the wireless network device 15. When the operating system loads the driver, the disabled signal is sent to the wireless network device 15 automatically to disable the scanning module 152 at once. Therefore, the automatic scanning function is disabled when the computer is booted. Then, power is saved, and the battery life of the portable electronic device 10 is prolonged.

On the other hand, after the conventional portable electronic device 10 establishes a link, it scans automatically and periodically via the scanning module 152 of the wireless network device 15 to know the states of the wireless access points 51 to 53 in the transmission range of the wireless network device 15 at any time. When the network link is abnormal or the user wants to replace the wireless access points 51 to 53, the scanning module 152 can provide the newest information. However, with the increase of the linking time, the times of automatically scanning are increased. Therefore, great power is wasted.

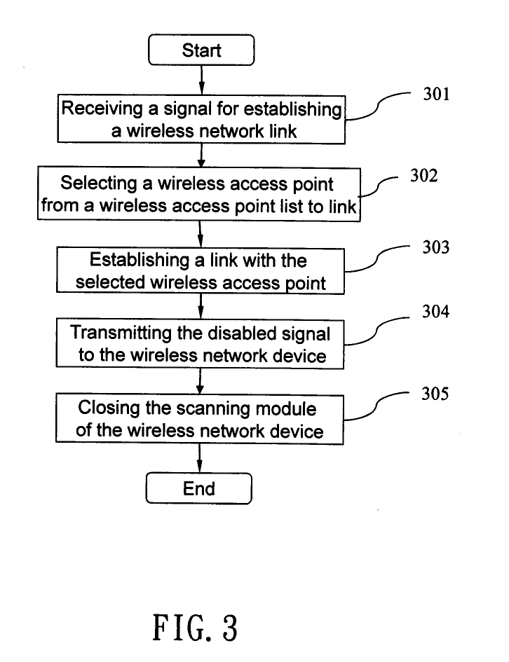

To aim at the shortcoming of periodically automatically scanning after establishing the link, please refer to FIG. 3, a flow chart of a power-saving control method for wireless LAN according to an another embodiment of the present invention.

When the signal for establishing a wireless network link inputted by the user is received (step 301), generally speaking, the wireless network link establishing program provided by the operating system in the portable electronic device 10 is used as the application programming interface (API) for communicating the user. At that moment, the wireless access point list is provided for user to select a wireless access point to link (step 302). The wireless access point list may be established by scanning via the scanning module 152 of the wireless network device 15 after the user inputs a signal for establishing the wireless network link. The wireless access point list also may be established beforehand, and it can be called when the user wants to use. The time of beforehand establishment may be the time after booting, which is the same as that described in the antecedent embodiment.

Then, one of the wireless access points 51 to 53 (step 303) selected by the user is linked. At that moment, the disabled signal is send to the wireless network device 15 (step 304) to close the scanning module 15 of the wireless network device 15 (step 305). Thus, the disabled signal can be combined with a wireless network link establishing program in the operating system. When the wireless network link establishing program is executed to establish the wireless network link, the disabled signal is sent to the wireless network device 15 automatically to disable the scanning module 152 at once after the link is established. Thus, the periodical automatic scanning function is disabled to save the power and prolong the battery life of the portable electronic device 10.

On the other hand, in the above-mentioned embodiment described in

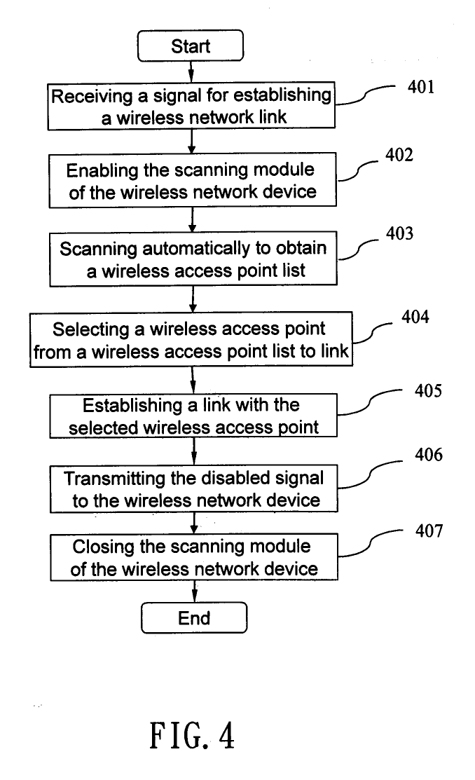

FIG. 2, when the link needs to be established, the power-saving control method shown in FIG. 3 is applicable. Please refer to FIG. 4, a flow chart showing the steps of establishing link of the embodiment in FIG. 2 of the power-saving control method for wireless LAN.

When the signal for establishing wireless network link inputted by the user is received (step 401), since the scanning module 152 of the wireless network device is disabled previously, it needs to be enabled (step 402). Then, the scanning module 152 is used to automatically scan to obtain the wireless access point list of all the wireless access points 51 to 53 in the current transmission range (step 403) for a user to establish a link with one from the wireless access points (step 404). If the list is established before (such as step 206), the user can use the wireless access point list established before directly. Moreover, if a user worries that the states of the wireless access points 51 to 53 have changed due to the long time after booting, he may make a scan again.

Then, one of the wireless access points 51 to 53 (step 405) selected by the user is linked. Then, the disabled signal is sent to the wireless network device 15 at the same time (step 406). The scanning module 152 of the wireless network device 15 is closed again (step 407). Therefore, after the wireless network link is established, the scan module 152 is disabled again, and the periodical automatic scanning is avoided to save power.

Therefore, the power-saving control method for wireless LAN disclosed in the invention resolve the problems in a conventional portable electronic device. In the conventional portable electronic device, wireless access points are scanned automatically after the portable electronic device is booted, and the wireless access points are periodically and automatically scanned after the network link is established. Thus, the power is wasted. In our invention, a driver sends a disabled signal to the wireless network device to close the scanning module after booting. In addition, the disabled signal is also added to the wireless network link establishing program. After the wireless network is established, the scanning module is closed. Therefore, the power used for periodically automatically scanning may be saved, and the battery life of the portable electronic device is prolonged.

Although the invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A power-saving control method for a wireless LAN, adapted for a portable electronic device with a wireless network device, the power-saving control method comprising:
receiving a booting signal;
loading a basic input/output system of the portable electronic device;
initializing a control chipset and a memory of the portable electronic device;
starting an operating system of the portable electronic device;
loading a driver of the wireless network device of the portable electronic device by the operating system;
transmitting a disabled signal to the wireless network device; and
closing a scanning module of the wireless network device.

2. The power-saving control method according to claim 1, wherein the disabled signal is combined with the driver, and the disabled signal is transmitted to the wireless network device automatically when the operating system loads the driver.

3. The power-saving control method according to claim 1, wherein before the step of transmitting the disabled signal to the wireless network device, the method further comprises a step of scanning automatically by the scanning module of the wireless network device to obtain a wireless access point list.

4. The power-saving control method according to claim 3, wherein the wireless access point list provides a choice for user to establish a wireless network link.

5. The power-saving control method according to claim 1, further comprising:
receiving a signal for establishing a wireless network link;
enabling the scanning module of the wireless network device;
scanning automatically by the scanning module of the wireless network device to obtain a wireless access point list;
selecting one wireless access point from the wireless access point list;
establishing a link with the selected wireless access point;
transmitting a disabled signal to the wireless network device; and
closing the scanning module of the wireless network device.

6. A power-saving control method for a wireless LAN, adapted for a portable electronic device with a wireless network device, the power-saving control method comprising:
receiving a signal for establishing a wireless network link;
selecting a wireless access point from a wireless access point list to link;
establishing a link with the selected wireless access point;
transmitting a disabled signal to the wireless network device; and
closing a scanning module of the wireless network device.

7. The power-saving control method according to claim 6, wherein the disabled signal is combined with a wireless network link establishing program, and the disabled signal is sent to the wireless network device automatically when the link is established with the selected wireless access point.

8. The power-saving control method according to claim 6, wherein the wireless access point list is obtained by automatically scanning by the scanning module of the wireless network device after the signal for establishing a wireless network link is received.

9. The power-saving control method according to claim 6, wherein the wireless access point list is established by automatically scanning by the scanning module of the wireless network device beforehand.

10. The power-saving control method according to claim 9, wherein the wireless access point list is established automatically after the portable electronic device is booted.
